(19) United States
(12) Patent Application Publication
(10) Pub. No.: US 2026/0208740 A1
(43) Pub. Date: Jul. 23, 2026

(54) ENGINE BRAKING FUNCTION FOR A CONTINUOUSLY VARIABLE TRANSMISSION

(71) Applicant: ZF Friedrichshafen AG, Friedrichshafen (DE)

(72) Inventor: Simon Geiger, Oberteuringen (DE)

(73) Assignee: ZF Friedrichshafen AG, Friedrichshafen (DE)

(21) Appl. No.: 19/139,542

(22) PCT Filed: Nov. 20, 2023
(86) PCT No.: PCT/EP2023/082317

§ 371 Date: Jun. 16, 2025

(30) Foreign Application Priority Data
Dec. 16, 2022 (DE) 10 2022 213 789.2

(51) Int. Cl. B60W 30/184; B60W 10/101; B60W 10/18

(52) U.S. Cl. CPC B60W 30/184; B60W 10/101; B60W 10/18; B60W 2510/0657; B60W 2510/105; B60W 2710/105

(57) ABSTRACT

A method is provided for controlling the transmission ratio (105) in a continuously variable transmission that is included in a drivetrain of a vehicle. The transmission ratio (105) is controlled during traction operation such that a magnitude of torque acting on a drivetrain shaft does not overshoot a first limit function (101), which assigns a torque limit (107) to each transmission ratio (105), where the torque acts on the shaft at maximum torque load of the drivetrain in traction operation. The transmission ratio (105) is controlled during overrun operation such that a magnitude of torque acting on the shaft does not overshoot a second limit function (103), which assigns to every transmission ratio a torque limit (107) which acts on the shaft in the case of maximum torque load on a part of the drivetrain downstream of an engine of the drivetrain in overrun operation.

### RELATED APPLICATIONS

This application claims the benefit under 35 U.S.C. § 371 as a U.S. National Phase Application of application no. PCT/EP2023/082317, filed on 20 Nov. 2023, which claims the benefit of German Patent Application no. 10 2022 213 789.2, filed on 16 Dec. 2022, the contents of which are hereby incorporated herein by reference in their entireties.

### FIELD OF THE DISCLOSURE

The invention relates to a method according for engine braking and to a computer program configured to execute such a method.

### BACKGROUND

The prior art includes automatic transmission control systems that implement an engine brake. A corresponding provision is disclosed, for example, in JP 6 11 46 645 A2. To achieve an engine braking effect, the transmission is prevented from shifting up.

The control is subject to torque limitation. This is intended to protect the drivetrain from overload. The maximum engine torque and the torque capacity of the downstream drivetrain are taken into account when limiting the torque.

### SUMMARY

The invention is based on the task of improving the braking effect of a drivetrain with a continuously variable transmission. This task is solved by a method according to claim 1 and a computer program according to claim 6. Preferred further developments are listed in the sub-claims.

The method is used to control the transmission ratio of a continuously variable transmission contained in a drivetrain of a vehicle. A continuously variable transmission, also known as CVT, is a transmission in which the transmission ratio between the input and output shafts can be adjusted continuously. For example, it could be a continuously variable power-split transmission used in construction machinery.

In addition to the transmission, the drivetrain comprises all torque-transmitting components that are located in a torque flow path from the engine to the driven wheels of the vehicle. The engine, one or more drive shafts, and one or more axle differentials are also part of the drivetrain.

The drivetrain can be operated during the traction operation or during the overrun operation. During the traction operation, the engine generates a drive torque that provides propulsion. During the overrun operation, the drivetrain is subjected to a torque flow in the opposite direction. This torque flow has a braking effect and thus counteracts the propulsion of the vehicle.

During the traction operation, the transmission ratio of the transmission is controlled so that the torque acting on a shaft in the drivetrain does not overshoot a first limit function. Specifically, the transmission ratio is controlled so that the torque acting on the shaft does not overshoot a torque limit that corresponds to the first limit function of the corresponding transmission ratio of the transmission. The shaft can be any shaft in the drivetrain whose torque can be determined. Preferably, this is a shaft equipped with a torque sensor.

The first limit function assigns a torque limit acting on the shaft to each transmission ratio of the transmission. This occurs when the entire drivetrain is loaded with the maximum possible torque during the traction operation. At the maximum possible torque load of the drivetrain during the traction operation, the specified torque limit is therefore applied to the shaft.

During the overrun operation, the transmission ratio of the transmission is controlled analogously by means of a second limit function. The transmission ratio is controlled in detail so that the torque acting on the shaft does not overshoot a torque limit that is assigned to the second limit function of the corresponding transmission ratio of the transmission.

According to the invention, the second limit function assigns a torque limit to each transmission ratio of the transmission, which corresponds to the maximum possible torque load on a part of the drivetrain downstream of the engine during the overrun operation. This torque limit is reached when the maximum torque load of the specified part of the drivetrain is applied to the shaft during the overrun operation. According to the invention, the maximum braking effect that the part of the drivetrain downstream of the engine can withstand without damage is therefore utilized. This makes it possible to utilize the maximum possible braking effect of the engine while taking into account the load capacity of the downstream part of the drivetrain.

The rear part of the drivetrain refers to the part of the drivetrain located between the engine and the driven wheels of the vehicle. This part of the drivetrain may include the transmission, one or more drive shafts, and/or one or more axle differentials.

In a preferred further development, the first limit function and the second limit function are different for at least one transmission ratio of the transmission. Specifically, the torque limit that assigns the first limit function to at least one transmission ratio of the transmission differs from the torque limit that assigns the second limit function to the same transmission ratio.

The differences between the first limit function and the second limit function, which are due to further development, correspond to different load capacities of the drivetrain during the traction operation and during the overrun operation. Further development makes it possible to take these differences into account when regulating the transmission ratio.

In a further preferred embodiment, the second limit function for at least one transmission ratio of the transmission is greater than the first limit function. Specifically, a torque limit that assigns the second limit function to at least one transmission ratio of the transmission is greater than the torque limit that assigns the first limit function to the same transmission ratio. This means that, in accordance with the further development, a higher torque can be transmitted during the overrun operation than during the traction operation.

In a further preferred configuration, the engine is adapted so that it can generate increased braking torque. This can be achieved, for example, by means of variable valve control. During the overrun operation, the movements of the pistons can then be specifically impeded by closed valves. Accordingly, the further development stipulates that the torque with which the engine acts on the downstream part of the drivetrain must be greater in terms of magnitude for at least one speed during the overrun operation than during the traction operation.

If it turns out that, during the overrun operation, the torque acting on the shaft overshoots the second limit function or a torque limit that assigns the second limit function to the respective transmission ratio of the transmission, then a brake on the vehicle is automatically applied in a further preferred embodiment. This supports the engine braking according to the invention.

A computer program according to the invention implements the method according to the invention or a preferred further development. The computer program is therefore designed to execute the method according to the invention or a preferred further development of the method. This means that the computer program includes instructions for executing the method according to the invention or a preferred further development thereof. The computer program causes a transmission control device to execute the method according to the invention or a preferred further development when the computer program is executed by the transmission control device.

The computer program may be contained in the transmission control device, stored on a storage medium, or encoded in one or more transmissible or transmitted signals. In particular, the computer program may exist as a computer program product, i.e., as a marketable unit or a unit that serves the purpose of transferring ownership of the computer program. The computer program can exist not only as software, but also in the form of hardware-based circuit logic.

### BRIEF DESCRIPTION OF THE DRAWINGS

A preferred exemplary embodiment of the invention is shown in FIG. 1, the sole figure. In detail, this shows:

FIG. 1: two limit functions.

### DETAILED DESCRIPTION

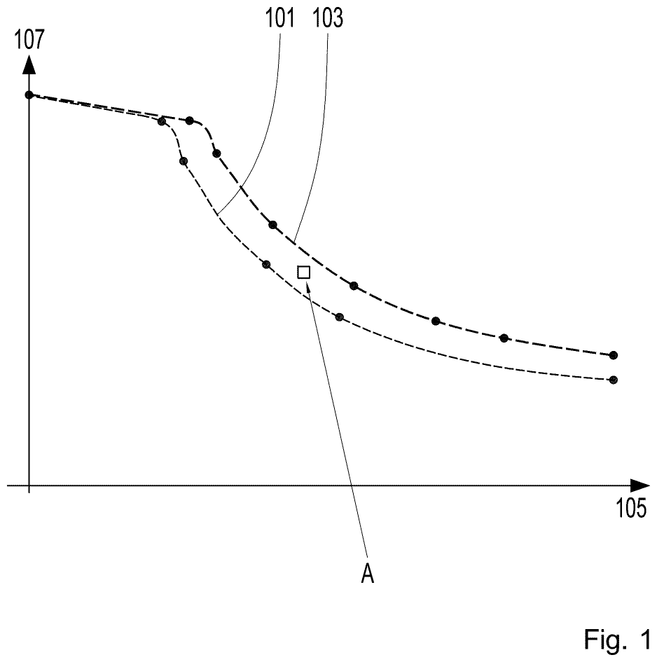

FIG. 1 shows a first limit function 101 and a second limit function 103. The two limit functions 101, 103 assign a maximum output torque 107 to each transmission ratio or reciprocity transmission ratio 105 of a continuously variable transmission.

The first limit function 101 corresponds to the maximum torque load capacity of the entire drivetrain during the traction operation. The drivetrain also includes an engine. This limits the maximum load capacity of the drivetrain at higher reciprocity transmission ratios 105.

The second limit function 103 corresponds to the maximum torque load capacity of a part of the drivetrain downstream of the engine during the overrun operation. A limitation by the engine is not included in the second limit function 103. Therefore, the second limit function 103 allows higher torque loads for larger reciprocity transmission ratios.

A indicates an operating state during the overrun operation. The output torque 107 present in state A exceeds the permissible torque limit specified by the first limit function 101 for the corresponding reciprocity transmission ratio 105. If the first limit function were used to control the transmission ratio during the overrun operation, the reciprocity transmission ratio 105 would have to be increased accordingly However, this would result in reduced braking performance.

To make the most of the drivetrain's load capacity, the second limit function 103 is used instead. This allows a higher output torque 107 in reciprocity transmission ratio 105 of operating state A. This increases the braking torque that can be achieved.

### REFERENCE NUMBERS

101 limit function
103 limit function
105 reciprocity transmission ratio
107 output torque

1. A method for controlling the transmission ratio (105) in a continuously variable transmission that is included in a drivetrain of a vehicle, the method comprising:
controlling the transmission ratio (105) during traction operation such that an absolute value of a torque acting on a shaft of the drivetrain does not overshoot a first limit function (101) which assigns a torque limit (107) to each transmission (105) of the transmission, which torque acts on the shaft at maximum torque load of the drivetrain in traction operation;
controlling the transmission ratio (105) during overrun operation such that an absolute value of a torque acting on the shaft does not overshoot a second limit function (103), characterized in that
assigning, by the second limit function (103), a torque limit (107) to every transmission ratio of the transmission, which torque acts on the shaft in the presence of a maximum torque load, during overrun operation, on a part of the drivetrain which is downstream of an engine of the drivetrain.

2. The method according to claim 1; wherein the first limit function (101) and the second limit function (103) are different for at least one transmission ratio (105) of the transmission.

3. The method according to claim 2, wherein the second limit function (103) is greater than the first limit function (101) for at least one transmission ratio of the transmission.

4. The method according to claim 3, wherein a torque with which the engine acts on the downstream part of the drivetrain is greater in magnitude than during the traction operation for at least one speed during the overrun operation.

5. The method according to claim 1, comprising:
determining that a magnitude of the torque (107) acting on the shaft overshoots the second limit function (103); and
applying automatically a brake of the vehicle.

6. A computer program product containing machine-readable code that cause a transmission control device of a vehicle to control the transmission ratio (105) of a continuously variable transmission contained in a drivetrain of the vehicle in accordance with the method according to claim 1.
